(19) United States
(12) Patent Application Publication
(10) Pub. No.: US 2026/0331649 A1
(43) Pub. Date: Oct. 22, 2026

(54) MICRO-THIN CELL WITH METAL CASE

(71) Applicant: Ultralife Corporation, Newark, NY (US)

(72) Inventors: Michael Edward Manna, Canandaigua, NY (US); Xinrong Wang, Fairport, NY (US); John M. Domm, Macedon, NY (US)

(73) Assignee: Ultralife Corporation, Newark, NY (US)

(21) Appl. No.: 19/650,442

(22) Filed: Apr. 17, 2026

Related U.S. Application Data
(60) Provisional application No. 63/790,800, filed on Apr. 18, 2025.

(51) Int. Cl. H01M 50/119; H01M 50/103

(52) U.S. Cl. CPC H01M 50/119; H01M 50/103

(57) ABSTRACT

Micro-thin battery cells, having a metal case, enable high-capacity and high-energy batteries for applications such as wearable sensors and tracking sensors. The micro-thin cell uses its case as a terminal and current collector for an electrode, enabling a cell shape that requires only a single electrode tab which connects another electrode of the battery cell.

### PRIORITY INFORMATION

The present application claims priority, under 35 U.S.C. § 119(e), from U.S. Provisional Patent Application, Ser. No. 63/790,800, filed on Apr. 18, 2026. The entire content of U.S. Provisional Patent Application, Ser. No. 63/790,800, filed on Apr. 18, 2026, is hereby incorporated by reference.

### BACKGROUND

Recently, the technologies in fields such as medical devices and electronic sensors have advanced in miniaturization and increased capabilities. For example, medical wearable sensors and tracking sensors are becoming smaller and thinner. Accordingly, such devices need smaller, thinner and their batteries should have increased capacity. Conventionally, small coin or button cells with sliver oxide chemistry are widely used in the medical wearable sensor and tracking sensor applications. However, their cell voltage is around 1.5V leading to lower energy, and their cell thickness is 1.5 mm or thicker.

To achieve high capacity and high energy storage for battery in a limited space, there are two options. One option is to find battery chemistry with higher energy density active materials for electrodes, such as anode active material and cathode active material. Another option is to reduce the thickness and usage of non-active materials which form the battery, such as packaging material, current collector and separator.

Traditional thin cells use aluminum laminate as packaging material and they might achieve thin thickness, however, X and Y dimensions could not be reduced to preferred size ranges due to the edge's minimum width of about 3 mm for heat sealing of the foil packet or housing.

Moreover, the electrodes of the anode and the cathode need a current collector to connect active materials and terminals.

Thus, it is desirable to provide a thin cell battery that has high capacity and high energy density.

Moreover, it is desirable to provide a thin cell battery that has smaller size and thinner thickness.

Additionally, it is desirable to provide a thin cell battery which is easy to install in application devices due to a metal case being one terminal and only a single metal tab as another terminal.

Also, it is desirable to provide a thin cell battery that occupies a smaller footprint in application device.

### BRIEF DESCRIPTION OF THE DRAWINGS

The drawings are only for purposes of illustrating various embodiments and are not to be construed as limiting, wherein:

FIG. 1 is a schematic illustration of an embodiment of a micro-thin battery cell;

FIG. 2 is a schematic illustration of another embodiment of a micro-thin battery cell;

FIG. 3 is a chart showing the discharge curve for a first example embodiment; and

FIG. 4 is a chart showing the discharge curve for a second example embodiment.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

The disclosed embodiments are directed to lithium energy cell design having a metal case and unique shape to form micro-thin cells having a small area and thin thickness. Such cells exhibit high capacity, high energy, and high energy density compared to conventional coin cells used for medical wearable devices. For example, regular coin cells with silver oxide chemistry have a voltage of 1.5 V and a thickness more than 1.5 mm with about 20 mAh of capacity.

The disclosed micro-thin cell lithium batteries include a metal enclosure (e.g., foils, foil envelopes, etc.) as the battery cell case and as one of the terminals (either the positive terminal or negative terminal) of the battery. A metal tab is electrically isolated (insulated) from and extends out of the metal case as the second terminal (either the negative terminal or positive terminal. respectively). The voltage of the disclosed cell will be 3 V or higher. Due to the higher voltage, the energy is double that of the conventional coin cells used for medical wearable devices. With the increased energy density, the disclosed embodiments essentially double the energy capacity of similarly sized or larger conventional cells.

A conventional thin cell or pouch cell has laminate material (e.g., aluminum and polymer multi-layer) as the case and two terminal tabs (positive and negative) with a sealant. There are cell components inside the thin cell that include an anode (−) and cathode (+) with a separator sandwiched between, as well as electrolyte. The thin cell size generally is 25×25×2 mm or larger.

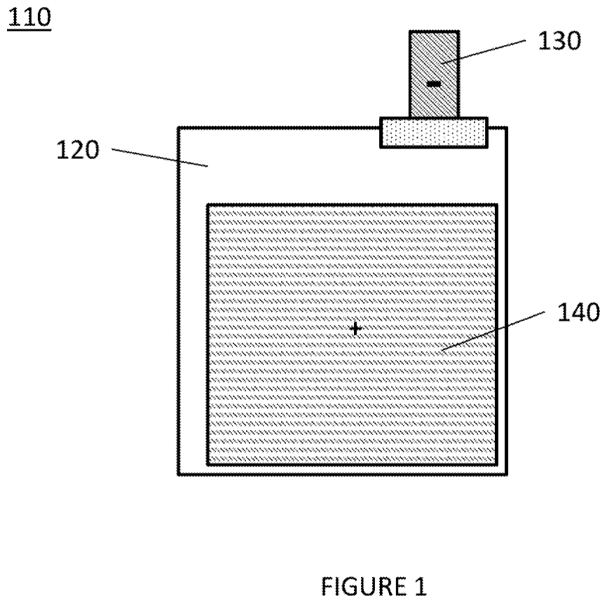

FIG. 1 is a schematic illustration of an embodiment of a micro-thin battery cell. As illustrated in FIG. 1, a micro-thin cell 110 includes a metal case 120 that forms a positive (+) terminal for the micro-thin cell 110. The micro-thin cell 110 also includes a terminal tab 130 that forms a negative (−) terminal for the micro-thin cell 110. Within the metal case 120, the micro-thin cell 110 includes cell components 140. The cell components 140 include an anode (−) (not shown) and a cathode (+) (not shown) with a separator (not shown) sandwiched between, as well as electrolyte (not shown).

As illustrated in FIG. 1, the micro-thin cell 110 has a shape that includes a cross-sectional shaped surface (metal case 120) having an appendage (terminal tab 130) projecting therefrom and having a cross-sectional appendage surface. A cross-sectional surface area of the cross-sectional shaped surface (metal case 120) is greater that a cross-sectional area of the cross-sectional appendage surface (terminal tab 130). The cross-sectional surface area of the cross-sectional shaped surface (metal case 120), as illustrated in FIG. 1, resembles a square, and the cross-sectional appendage surface (terminal tab 130) resembles a rectangle.

Moreover, the cross-sectional shaped surface (metal case 120) is substantially coplanar with the cross-sectional appendage surface of the appendage such that, as illustrated in FIG. 1, the overall shape of the micro-thin cell 110 resembles a “P” or a cross-sectional area with a projecting stem, wherein the cross-sectional area with a projecting stem are substantially coplanar.

It is noted that the cross-sectional shaped surface (metal case 120) may be a circle, a triangle, a rectangle, heart shape, apple shape, tear drop shape, any multi-side shape, or any irregular shape that would allow the micro-thin cell 110 to be easier installed in a battery driven appliance.

It is noted that the cross-sectional appendage surface (terminal tab 130) may be a circle, a triangle, a rectangle, heart shape, apple shape, tear drop shape, any multi-side shape, or any irregular shape that would allow the micro-thin cell 110 to effectively provide a second terminal for the battery driven appliance.

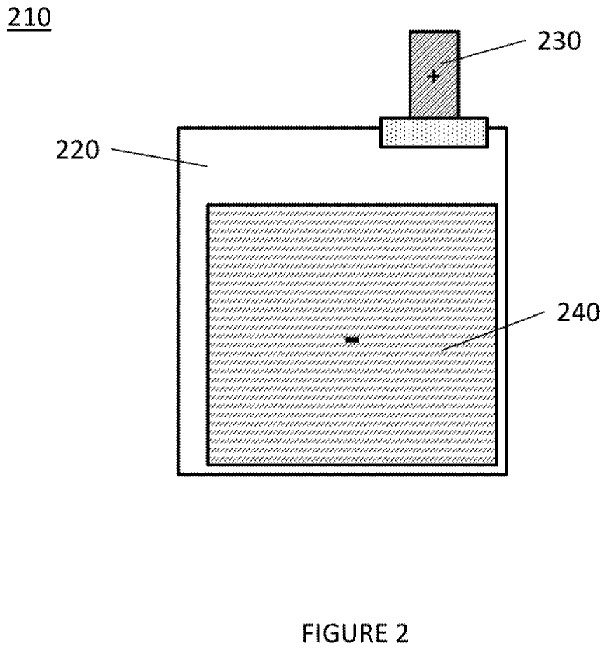

FIG. 2 is a schematic illustration of an embodiment of a micro-thin battery cell. As illustrated in FIG. 2, a micro-thin cell 210 includes a metal case 220 that forms a negative (−) terminal for the micro-thin cell 210. The micro-thin cell 210 also includes a terminal tab 230 that forms a positive (+) terminal for the micro-thin cell 210. Within the metal case 220, the micro-thin cell 210 includes cell components 240. The cell components 240 include an anode (−) (not shown) and a cathode (+) (not shown) with a separator (not shown) sandwiched between, as well as electrolyte (not shown).

As illustrated in FIG. 2, the micro-thin cell 210 has a shape that includes a cross-sectional shaped surface (metal case 220) having an appendage (terminal tab 230) projecting therefrom and having a cross-sectional appendage surface. A cross-sectional surface area of the cross-sectional shaped surface (metal case 220) is greater that a cross-sectional area of the cross-sectional appendage surface (terminal tab 230). The cross-sectional surface area of the cross-sectional shaped surface (metal case 220), as illustrated in FIG. 2, resembles a square, and the cross-sectional appendage surface (terminal tab 230) resembles a rectangle.

Moreover, the cross-sectional shaped surface (metal case 220) is substantially coplanar with the cross-sectional appendage surface of the appendage such that, as illustrated in FIG. 2, the overall shape of the micro-thin cell 210 resembles a “P” or a cross-sectional area with a projecting stem, wherein the cross-sectional area with a projecting stem are substantially coplanar.

It is noted that the cross-sectional shaped surface (metal case 220) may be a circle, a triangle, a rectangle, heart shape, apple shape, tear drop shape, any multi-side shape, or any irregular shape that would allow the micro-thin cell 210 to be easier installed in a battery driven appliance.

It is noted that the cross-sectional appendage surface (terminal tab 230) may be a circle, a triangle, a rectangle, heart shape, apple shape, tear drop shape, any multi-side shape, or any irregular shape that would allow the micro-thin cell 210 to effectively provide a second terminal for the battery driven appliance.

It is noted that the cross-sectional surface area of the appendage (terminal tab 230) may be a circle, a triangle, a rectangle, or any multi-side shape that would allow the micro-thin cell 110 to effectively provide a second terminal for the battery driven appliance.

. With respect to the micro-thin cells of FIGS. 1 and 2, the cell size can be 8×11×1.35 mm or smaller and thinner.

A micro-thin cell of such size has a capacity of twenty-one mAh or higher. Advantages of such micro-thin cells include: 1) easy installation to application devices due to a metal case as one terminal and only one metal tab as another terminal; 2) high capacity and high energy compared to conventional thin cell or coin cell batteries; and 3) smaller size and thinner thickness for the battery, which saves space for application devices such as medical sensors and tracking sensors.

The metal for case of the micro-thin cell of FIGS. 1 and 2 can be made from a number of materials including, but not limited to, aluminum, stainless steel, nickel, titanium, copper, silver and gold. The tab metal of the micro-thin cell of FIGS. 1 and 2 can be made from a number of materials including, but not limited to, nickel, aluminum, stainless steel, titanium, copper, silver and gold. The thickness of the metal for case of the micro-thin cell of FIGS. 1 and 2 can be 100 micrometers, or thinner down to 5 micrometers. The thickness of metal for tab of the micro-thin cell of FIGS. 1 and 2 can be 100 micrometers, or thinner down to 5 micrometers. The tab metal is isolated from the case metal with a polymer coating that can include, but is not limited to polyethylene, polypropylene, polyester, etc. and their copolymers.

Inside the micro-thin cell case of the micro-thin cell of FIGS. 1 and 2, there are an anode and a cathode, a separator and electrolyte.

For lithium metal non-rechargeable cells, the anode is lithium metal, and the cathode can be, but is not limited to, manganese dioxide (MnO₂) and carbon, binder composite, or blended fluorided carbon (CFₓ) and manganese dioxide (MnO₂) and carbon, binder composite.

For Li-ion rechargeable cells, the anode electrode active materials may include, but are not limited to, graphite or graphite-silicon composites.

The cathode electrode active material may include, but is not limited to, Lithium Nickel Manganese Cobalt oxide (NMC), Lithium Cobalt oxide (LiCoO₂), Lithium Iron Phosphate (LFP), Lithium Manganese Iron Phosphate (LMFP) and others. The conductive agent could be carbon black, graphite, and other forms of carbon materials. The aqueous binder for anode and cathode electrodes could include, but is not limited to, Polyvinylidene fluoride PVDF, Polytetrafluoroethylene (PTFE), Carboxymethyl cellulose (CMC), Styrene-Butadiene Rubber (SRB) and others with additives. The electrolyte can be, but is not limited to, lithium salt in organic solvents, or a gel electrolyte.

The following examples are provided as illustrations and should not be interpreted as constituting any limitation of the disclosed embodiments.

### Example 1

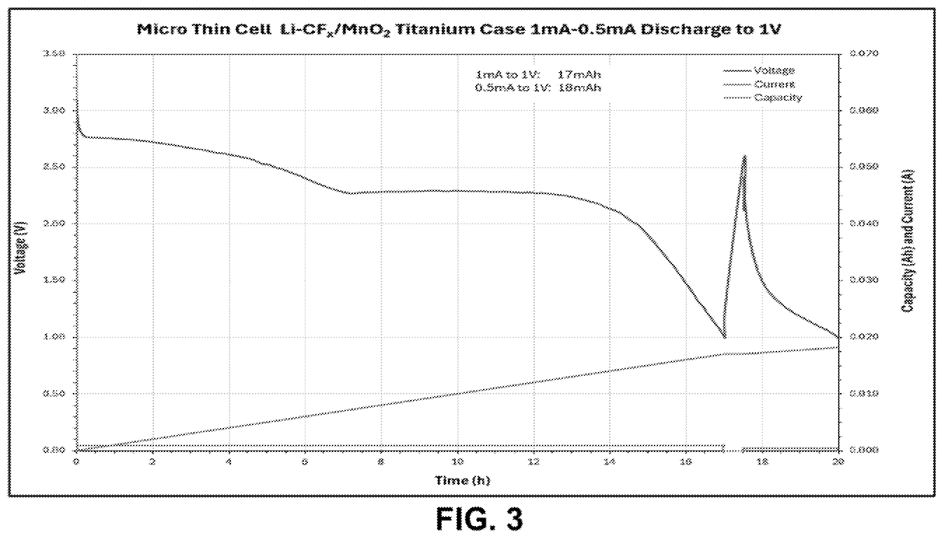

A titanium encased micro-thin cell is made of a titanium foil (15 μm thick), with lithium metal electrically contacting the titanium case, a polymer separator, CFₓ/MnO₂ hybrid cathode and electrolyte with lithium salt in organic co-solvents. The titanium metal case can be formed as deep drawn can, or as a folded metal foil pouch or pocket, with the edges welded or sealed by using an ultrasonic welder or laser welder. A metal tab with an insulating coating/sealant is attached to the cathode and is sealed to the metal case along the edge by heat sealing. The cell thickness is 1.13 mm. The titanium metal case is the negative (−) terminal, and an aluminum tab connected to the cathode is the positive (+) terminal. The discharge curve for this first example embodiment is shown in FIG. 3. It shows 18 mAh of capacity for 0.5 mA to 1 V cutoff. As 0.1 mA discharge to 1 V, the capacity is expected to be 22 mAh.

### Example 2

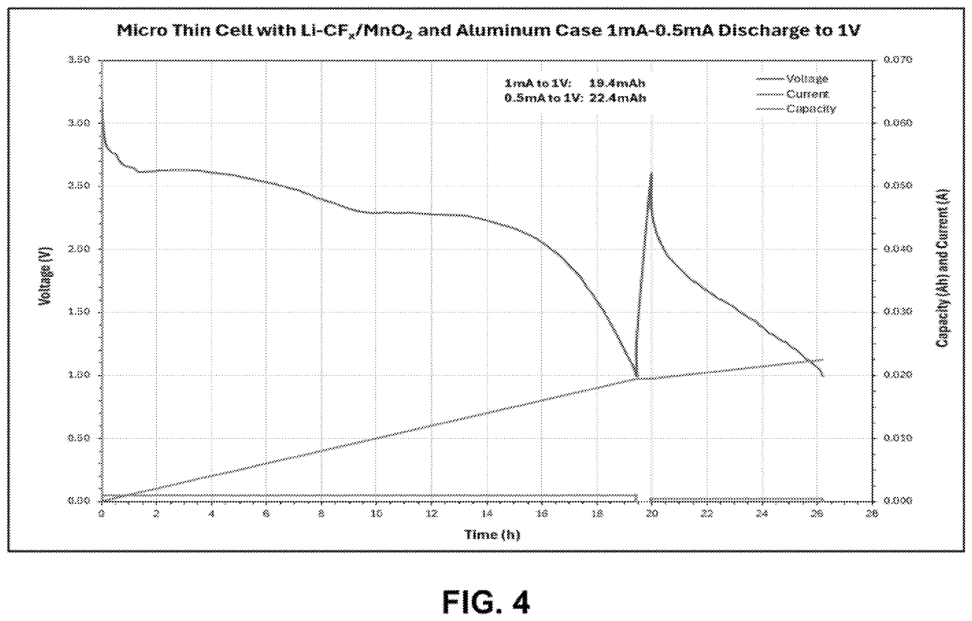

An aluminum encased micro-thin cell is made of aluminum foil (e.g., 100 μm thick), an aluminum current collector of CFₓ/MnO₂ and the hybrid cathode is electrically connected to the aluminum case, a polymer separator, an anode lithium and electrolyte with lithium salt in organic co-solvents. As above, the metal case can be formed as a deep drawn can or by folding a metal foil and then welding the edges using ultrasonic welder or laser welder. The partially insulated metal tab is sealed where it penetrates the metal case by using heat sealer. The cell thickness is 1.35 mm. The aluminum metal case is a positive (+) terminal, and a nickel tab connected to the lithium anode serves as the negative (−) terminal. The discharge curve for this example is shown in the FIG. 4. It shows 22.4 mAh of capacity for 0.5 mA to 1 V cutoff. As 0.1 mA discharge to 1 V, the capacity is expected to be 26.4 mAh.

The disclosed embodiments relate to the construction of micro-thin battery cells using a unique shape metal case, which houses the cells to enable high-capacity and high-energy batteries for different applications such as medical wearable sensors and tracking sensors. The micro-thin cell employs a unique cell shape that may be characterized as a “P-shape” as described in detail below.

The cell size can be 8×11×1.35 mm, and possibly smaller and thinner. Practically, the size reduction (including thickness) is a function of the case thickness and layered cell components therein. Thus, cell thicknesses of less than 1.5 mm, and as thin as about 1.0 mm may be possible for the cell with 21 mAh of capacity.

In one embodiment the cell has a capacity of 21 mAh or higher. The metal case can be made of different metals, with only micrometers of thickness, and the case can further serve as the positive (+) terminal or negative (−) terminal. A tab or stem is also made of metal or a similarly conductive material, and can be various metals, also with only micrometers of thickness. Corresponding to the case polarity, the tab can be the negative (−) terminal or the positive (+) terminal, accordingly.

When the capacity is lower, the cell size can be smaller as 7×10×1.35 mm, and 6×9×1.35 mm or thinner depending on the application capacity needs. Practically, the size reduction (including thickness) is a function of the case thickness and layered cell components therein. Thus, cell thicknesses of less than 1.5 mm, and as thin as about 0.4 mm may be possible.

When the capacity is higher, the cell size X and Y can be larger than 8×11 mm, the cell thickness will be less than 1.5 mm, and as thin as about 0.4 mm may be possible due to the unique “shape”, discussed above, using micro-meter thick metal case.

Some advantages of such micro-thin cells include: 1) easy installation to application devices due to metal case as one terminal and only a single metal tab as another terminal; 2) high capacity and high energy density compared to regular thin cell or coin cell batteries; 3) smaller size and thinner thickness for the battery that saves space for application devices.

Disclosed in embodiments herein is a micro-thin battery, comprising: a battery cell having a unique “P-shape” including an anode (−), a cathode (+) with a separator sandwiched therebetween, along with an electrolyte; a thin metal case, the metal case encapsulating the battery cell and electrically contacting only one of the anode or cathode, the thin metal case being sealed along its edge(s); and a metal terminal tab in electrical contact with the other of the anode or cathode, the metal terminal tab being electrically isolated from the metal case and protruding from an edge thereof.

Further disclosed in embodiments herein is a micro-thin battery, comprising a battery cell having a unique P-shape with a thin metal case as a first terminal of the battery cell and only one metal tab as a second terminal of the battery cell, where the battery cell includes an anode (−) and a cathode (+) with a separator sandwiched therebetween, along with an electrolyte.

In the current embodiments, the metal case is used as a current collector for either the anode or the cathode, while at the same time providing the case or housing for packaging the cell. This novel use of the metal case eliminates the packaging material of the conventional thin cell, so that the thinner thickness of the metal case further reduces the overall thickness of the cell. Furthermore, the minimum 3 mm sealing edge is only needed for one edge and not needed for all edges, and the cell size or footprint can be made smaller as well. In one embodiment a lithium battery chemistry (non-rechargeable or Li-ion rechargeable) is selected for high voltage, high capacity and high energy. Various challenges for metal case micro-thin cell assembly are solved by the various embodiments and approaches disclosed.

The case metal can be, but not limited to aluminum, stainless steel, nickel, titanium, copper, silver and gold. The tab metal can be, but not limited to nickel, aluminum, stainless steel, titanium, copper, silver and gold. The tab metal is isolated from case metal with polymer which can be, but not limited to polyethylene, polypropylene, polyester, others and their copolymers.

A micro-thin battery includes a battery cell having a first terminal of a first polarity and a second terminal of a second polarity, with a separator sandwiched therebetween; a metal case, the metal case encapsulating the battery cell and electrically contacting only the first terminal, the thin metal case being sealed; and a metal terminal tab in electrical contact with the second terminal, the metal terminal tab being electrically isolated from the metal case and protruding from an edge thereof; the metal case having a cross-sectional shaped surface, the a cross-sectional shaped surface having a first surface area; the metal terminal tab having a tab surface, the tab surface having a second surface area; the first surface area being greater than the second surface area; the first surface area being substantially coplanar with the second surface area.

The first terminal may be an anode and the second terminal may be a cathode. The second terminal may be an anode and the first terminal may be a cathode.

The first surface area and the second surface area may form a P-shape. A thickness of the battery may be less than 1.5 mm. The thickness of the battery may be less than 1.35 mm. A capacity may be at least 20 mAh. X and Y dimensions of the battery cell may be bigger than 8×11 mm.

The metal case may include a metal foil. The metal foil may have a thickness in the range of 5-100 micrometers. The metal case may include a drawn metal can. The drawn metal can may have a thickness in the range of 5-100 micrometers. The metal terminal tab may have a thickness in the range of 5-100 micrometers.

The cross-sectional shaped surface may be circle shaped. The cross-sectional shaped surface may be triangle shaped. The cross-sectional shaped surface may be square shaped. The cross-sectional shaped surface may be rectangle shaped. The cross-sectional shaped surface may be polygonal shaped. The cross-sectional shaped surface may be irregularly shaped.

The tab surface may be polygonal shaped. The tab surface may be irregularly shaped.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A micro-thin battery, comprising:
a battery cell having a first terminal of a first polarity and a second terminal of a second polarity, with a separator sandwiched therebetween;
a metal case, the metal case encapsulating the battery cell and electrically contacting only said first terminal, said thin metal case being sealed; and
a metal terminal tab in electrical contact with said second terminal, said metal terminal tab being electrically isolated from said metal case and protruding from an edge thereof;
said metal case having a cross-sectional shaped surface, said a cross-sectional shaped surface having a first surface area;
said metal terminal tab having a tab surface, said tab surface having a second surface area;
said first surface area being greater than said second surface area;
said first surface area being substantially coplanar with said second surface area.

2. The micro-thin battery, as claimed in claim 1, wherein said first terminal is an anode and said second terminal is a cathode.

3. The micro-thin battery, as claimed in claim 1, wherein said second terminal is an anode and said first terminal is a cathode.

4. The micro-thin battery, as claimed in claim 1, wherein said first surface area and said second surface area form a P-shape.

5. The micro-thin battery according to claim 1, wherein a thickness of the battery is less than 1.5 mm.

6. The micro-thin battery according to claim 1, wherein the thickness of the battery is less than 1.35 mm.

7. The micro-thin battery according to claim 1, wherein a capacity is at least 20 mAh.

8. The micro-thin battery according to according to claim 6, wherein X and Y dimensions of the battery cell are bigger than 8×11 mm.

9. The micro-thin battery according to claim 1, wherein said metal case includes a metal foil.

10. The micro-thin battery according to claim 9, wherein said metal foil has a thickness in the range of 5-100 micrometers.

11. The micro-thin battery according to claim 1, wherein said metal case includes a drawn metal can.

12. The micro-thin battery according to claim 11, wherein said drawn metal can has a thickness in the range of 5-100 micrometers.

13. The micro-thin battery according to claim 1, wherein said metal terminal tab has a thickness in the range of 5-100 micrometers.

14. The micro-thin battery according to claim 1, wherein said cross-sectional shaped surface is circle shaped.

15. The micro-thin battery according to claim 1, wherein said cross-sectional shaped surface is triangle shaped.

16. The micro-thin battery according to claim 1, wherein said cross-sectional shaped surface is square shaped.

17. The micro-thin battery according to claim 1, wherein said cross-sectional shaped surface is polygonal shaped.

18. The micro-thin battery according to claim 1, wherein said cross-sectional shaped surface is irregularly shaped.

19. The micro-thin battery according to claim 1, wherein said tab surface is polygonal shaped.

20. The micro-thin battery according to claim 1, wherein said tab surface is irregularly shaped.
